(19) United States
(12) Patent Application Publication
(10) Pub. No.: US 2008/0138483 A1
(43) Pub. Date: Jun. 12, 2008

(54) ANIMAL FEED COMPOSITION FOR INCREASED BIOACTIVITY AND PRODUCTION OF GLUTATHIONE PEROXIDASE AND SUPEROXIDE DISMUTASE

(76) Inventor: KEVIN MEEHAN, JACKSON, WY (US)

Correspondence Address: MARGER JOHNSON & MCCOLLOM, P.C., 210 SW MORRISON STREET, SUITE 400, PORTLAND, OR, 97204, US

(21) Appl. No.: 12/032,406

(22) Filed: Feb. 15, 2008

Related U.S. Application Data
(63) Continuation-in-part of application No. 11/351,538, filed on Feb. 9, 2006.
(60) Provisional application No. 60/651,784, filed on Feb. 9, 2005.

(51) Int. Cl. A23L 1/275; A23L 1/212; A23K 1/00

(52) U.S. Cl. 426/540; 426/615

(57) ABSTRACT

A serving of a food product for consumption by animals includes carotenoids, methionine, animal flesh, N-acetyl-cysteine, and sodium selenate.

### CROSS REFERENCE TO RELATED APPLICATIONS

This application is a Continuation-in-Part of U.S. Utility application Ser. No. 11/351,538, which was filed on 9 Feb. 2006, and which in turn claims priority from U.S. Provisional Patent Application No. 60/651,784, which was filed on 9 Feb. 2005. U.S. Ser. No. 11/351,538 and U.S. Provisional Patent Application No. 60/651,784 are incorporated by reference in their entirety.

### BACKGROUND

1. Technical Field

This disclosure relates generally to a feed composition, and more specifically to an animal feed composition formulated to increase the bioactivity and production of the enzymes glutathione peroxidase and superoxide dismutase in animals.

2. Description of the Related Art

The Merriam-Webster Medical Dictionary (2002) defines a carotenoid as any of various usually yellow to red pigments (as carotenes) found widely in plants and animals and characterized chemically by a long aliphatic polyene chain composed of eight isoprene units.

The Merriam-Webster® Medical Dictionary (2002) defines a methionine as a crystalline sulfur-containing essential amino acid C₅H₁₁NO₂S that occurs in the L-form as a constituent of many proteins (as casein and egg albumin), that is important especially as a source of sulfur for the biosynthesis of cysteine and as a source of methyl groups for transmethylation reactions (as in the biosynthesis of choline, creatine, and adrenaline), and that is used as a dietary supplement for human beings and their domestic mammals and poultry and in the treatment of fatty infiltration of the liver.

The Merriam-Webster® Medical Dictionary (2002) defines a cysteine as a sulfur-containing amino acid C₃H₇NO₂S that occurs in many proteins and glutathione and that is readily oxidizable to cystine.

The Merriam-Webster® Medical Dictionary (2002) defines an antioxidant as any of various substances (as beta-carotene, vitamin C, and alpha-tocopherol) that inhibit oxidation or reactions promoted by oxygen and peroxides and that include many held to protect the living body from the deleterious effects of free radicals.

The Merriam-Webster® Medical Dictionary (2002) defines glutathione as a peptide C₁₀H₁₇N₃O₆S that contains one amino acid residue each of glutamic acid, cysteine, and glycine, that occurs widely in plant and animal tissues, and that plays an important role in biological oxidation-reduction processes and as a coenzyme.

The Merriam-Webster® Medical Dictionary (2002) defines peroxidase as an enzyme occurring especially in plants, milk, and white blood cells and consisting of a protein complex with hematin groups that catalyzes the oxidation of various substances by peroxides.

The Merriam-Webster® Medical Dictionary (2002) defines superoxide dismutase as a metal-containing antioxidant enzyme that reduces potentially harmful free radicals of oxygen formed during normal metabolic cell processes to oxygen and hydrogen peroxide—abbreviation SOD.

The Merriam-Webster® Medical Dictionary (2002) defines an international unit as the amount of specific physiological activity of a standardized preparation (as of a vitamin) that is agreed upon as an international standard especially for comparison with other biologicals containing the substance in impure form or with a related biologically active substance; also: the amount of the biologically active substance in the standard amount of the preparation producing this activity.

### DETAILED DESCRIPTION OF EXAMPLE EMBODIMENTS

The design of this animal food product contemplates substantial nutrition coupled with a novel formulation which focuses on increasing the bioactivity and levels of the enzymes glutathione peroxidase and superoxide dismutase. The food components that are found in example embodiments provide the proteins required for mammals to achieve this goal as well as the necessary fiber which encourages bowel motility.

According to some example embodiments, the primary ingredients of an animal food product include, in order of decreasing weight, chicken, green cabbage, brown rice, and horseradish. The preferred ratio of these ingredients in these example embodiments is listed below in Table 1, where one pound of chicken is used as a reference. The vitamin, amino acid, and element ratio for the ingredients of Table 1 are listed below in Table 2.

TABLE 1

| | |
|---|---|
| 16 | ounces chicken |
| 4½ | ounces green cabbage |
| 3 | ounces brown rice, short grain |
| ½ | ounce horseradish |

TABLE 2

| | |
|---|---|
| 50,000 | International Units (IU) mixed carotenoids |
| 500 | milligrams (mg) L-methionine |
| 500 | mg N-acetyl-L-cysteine |
| 250 | micrograms (mcg) sodium selenate (selenium) |

The physiological action of the ingredients listed in Table 2 is described below. Selenium is a major component of glutathione peroxidase, which has been shown to negate superoxide anion free radicals (Oz′). Cysteine and methionine are both sulfur-containing side chain amino acids and influence the concentration of sulfur-containing biological compounds, such as glutathione (the component of glutathione peroxidase).

This formula functions to increase both the bioactivity and levels of the enzymes glutathione peroxidase and superoxide dismutase, aiding in protection of DNA in mammals, while also providing a low fat diet.

The mixed carotenoids are antioxidants in general.

Chicken is preferred because its meat or flesh has a relatively low fat concentration, but in alternative embodiments the flesh of other species of poultry or even other species of animal (e.g., beef, pork, veal) could be used as long as the vitamin, amino-acid, and element ratio of Table 2 is maintained.

It should be noted that maintaining the ratios of Table 2 does not necessarily mean that the ratio of vitamin, amino-acids, and elements listed in Table 2 are strictly held at that specific ratio. Rather, the actual ratio may be more or less than the preferred ratio by about 30% in either direction (30% more than the preferred ratio or 30% less than the preferred ratio) and still achieve the benefits according to example embodiments. Ratios below 30% of the preferred ratio may not give a significant benefit while ratios above 30% of the preferred ratio may actually be harmful, particularly with respect to the methionine.

Consequently, other example embodiments may have more ingredients than those listed in Table 1, but the other embodiments will still have, at the least, the same ratio that is exhibited between the elements of Table 2 relative to the total weight of the ingredients listed in Table 1. In other words, the ratios of carotenoids, sodium selenate, methionine, and cysteine for other embodiments of the invention may be approximately 30% more or less than the preferred ratios that can be calculated from Tables 1 and 2.

The brown rice encourages bowel motility, expediting the removal of unwanted material. Green cabbage and horseradish are both sulfur containing brassica family vegetables which increase levels of peroxidase and superoxide dismutase. In alternative embodiments other brassica family vegetables may be used in addition to the green cabbage and horseradish or in place of one or both of the green cabbage and horseradish.

According to some embodiments, an animal food product may consist only of the four ingredients listed in Table 1.

Table 3, which appears below, lists the primary ingredients included in another animal food product in accordance with example embodiments. The first column of Table 3 lists the constituent ingredient. The second column of Table 3 indicates the ratio of the weight of the ingredient (in pounds) to one pound of animal flesh. As before, the particular flesh that is used is preferably chicken, but other types of animal flesh may be used, for example, beef, pork, or veal. The third column of Table 3 lists the actual weight of the ingredient in pounds for one serving of the animal food product.

TABLE 3

| | | Actual |
|---|---|---|
| Ingredient | Ratio (per lb of flesh) | weight (in lbs) |
| Carotenoids | 4.409266e−5 | .005008 |
| L-Methionine | .0007342 | .0015024 |
| N-Acetyl-Cysteine | .00894 | .00168 |
| Sodium Selenate | 3.7e−7 | .0004006 |
| Horse Radish | .0121 | .0015 |
| Green Cabbage | .1875 | .1883013 |
| Brown Rice | .125 | .0500801 |

A noticeable difference between the formulation found in Tables 1 and 2 and the formulation of Table 3 is that the N-Acetyl-L-Cysteine has been replaced by N-Acetyl-Cysteine (N.A.C.), which is a delivery form of N-Acetyl-L-Cysteine. As N-Acetyl-L-Cysteine is hygroscopic, it oxidizes. N.A.C., on the other hand, is a much more stable form of the sulfur based amino acid and thus is better absorbed. N.A.C. is also a reducing agent and participates in anti-oxidant activities. Like the preferred ratios expressed in Tables 1 and 2, the preferred ratio expressed in Table 3 may vary by 30% either way and still achieve benefits in accordance with example embodiments.

A person skilled in the art will be able to practice the inventive principles in view of the exemplary embodiments described in this specification, where numerous details have been set forth in order to provide a more thorough understanding of the inventive principles. In some instances, well-known features have not been described in detail in order not to obscure unnecessarily the inventive principles.

Furthermore, having described and illustrated the inventive principles in the exemplary embodiments, it should be apparent that the exemplary embodiments may be modified in arrangement and detail without departing from such principles. I claim all modifications and variations coming within the spirit and scope of the following claims.

1. A food product for consumption by animals, a serving of food product comprising:
carotenoids;
methionine;
animal flesh;
N-acetyl-cysteine; and
sodium selenate.

2. The food product of claim 1, the methione consisting of L-methionine, a ratio of the L-methionine to a pound of the animal flesh approximately 0.007342, plus or minus 30%.

3. The food product of claim 2, a ratio of the N-acetyl-cysteine to the pound of the animal flesh approximately 0.00894, plus or minus 30%.

4. The food product of claim 3, a ratio of carotenoids to the pound of animal flesh approximately 4.409266×10⁻⁵, plus or minus 30%.

5. The food product of claim 4, a ratio of the sodium selenate to the pound of animal flesh approximately 3.7×10⁻⁷, plus or minus 30%.

6. The food product of claim 1, the serving further comprising:
brown rice;
at least one vegetable from the brassica family.

7. The food product of claim 6, a ratio of the at least one vegetable to the pound of animal flesh approximately 0.1996, plus or minus 30%.

8. The food product of claim 6, the at least one vegetable comprising:
green cabbage; and
horseradish.

9. The food product of claim 8, a ratio of green cabbage to the pound of animal flesh approximately 0.1875, plus or minus 30%.

10. The food product of claim 8, a ratio of horseradish to the pound of animal flesh approximately 0.0121, plus or minus 30%.

11. A food composition for consumption by mammals that is designed to increase the production of glutathione peroxidase and superoxide dismutase, a serving of the food composition comprising:
a meat;
a brassica vegetable; and
N-acetyl-cysteine.

12. The food composition of claim 11, a ratio of the brassica vegetable to a pound of the meat approximately 0.1996, plus or minus 30%.

13. The food composition of claim 12, the brassica vegetable comprising:
green cabbage; and
horseradish.

14. The food composition of claim 13, a ratio of green cabbage to the pound of the meat approximately 0.1875, plus or minus 30%.

15. The food composition of claim 11, the meat comprising chicken.

16. The food composition of claim 11, the serving further comprising:
carotenoids;
L-methionine; and
sodium selenate.

17. The food composition of claim 16, a ratio of carotenoids to a pound of the meat approximately 4.409266×10⁻⁵, plus or minus 30%.

18. The food composition of claim 16, a ratio of L-methionine to a pound of the meat approximately 0.0007342, plus or minus 30%.

19. The food composition of claim 16, a ratio of N-acetyl-cysteine to a pound of the meat approximately 0.00894, plus or minus 30%.

20. The food composition of claim 16, a ratio of sodium selenate to a pound of the meat approximately 3.7×10⁻⁷, plus or minus 30%.
